(19) United States
(12) Patent Application Publication
(10) Pub. No.: US 2016/0180560 A1
(43) Pub. Date: Jun. 23, 2016

(54) IMAGE INSERTION IN A MESSAGE

(71) Applicant: Created To Love, Inc., Solana Beach, CA (US)

(72) Inventors: Vipool M. Patel, Solana Beach, CA (US); Aaron Rau, Millbrae, CA (US); Joshua P. Lee, Encinitas, CA (US)

(21) Appl. No.: 14/574,290

(22) Filed: Dec. 17, 2014

(51) Int. Cl. G06T 11/60; G06T 1/00

(52) U.S. Cl. CPC G06T 11/60; G06T 1/0007

(57) ABSTRACT

To insert an image into a message, text is displayed in a current message display buffer of a communication device. At least one keyword derived from the text is displayed in a keyword display area. A plurality of images is displayed for a selected keyword when the selected keyword is selected from among the at least one keyword displayed in the keyword display area. An image is inserted into the current message display buffer from the plurality of images when the image is selected from among the plurality of images.

### BACKGROUND

A popular form of communication is to send short text messages electronically. Instant messaging uses communication technologies used for text-based communication between two or more participants over the Internet or other types of networks. Short Message Service (SMS) is a text messaging service component of phone, Internet, or mobile communication systems. Longer messages are often sent through electronic mail (e-mail).

Often messaging systems, like e-mail, allow attachment of files that enables sending other types of data besides text. For example, image data and sound data is often included in e-mails.

### BRIEF DESCRIPTION OF THE DRAWINGS

FIG. 1 shows a simplified block diagram of hardware components of a portable electronic device in accordance with the prior art.

FIG. 2 shows a simplified block diagram of hardware components of a network system that connects portable electronic device to server systems in accordance with the prior art.

FIG. 3 illustrates interaction of an image messaging system that facilitates image insertion in messages in accordance with an embodiment.

FIG. 4 illustrates a user interface within a system that facilitates image insertion in messages in accordance with an embodiment.

FIG. 5 illustrates keyword searching within a system that facilitates image insertion in messages in accordance with an embodiment.

FIG. 6 further illustrates a user interface within a system that facilitates image insertion in messages in accordance with an embodiment.

FIG. 7 illustrates image searching and selection within a system that facilitates image insertion in messages in accordance with an embodiment.

FIG. 8 further illustrates a user interface within a system that facilitates image insertion in messages in accordance with an embodiment.

FIG. 9 further illustrates a user interface within a system that facilitates image insertion in messages in accordance with an embodiment.

FIG. 10 further illustrates the ability to scroll through images within a system that facilitates image insertion in messages in accordance with an embodiment.

FIG. 11 further illustrates a completed message within a system that facilitates image insertion in messages in accordance with an embodiment.

FIG. 12, FIG. 13, FIG. 14 and FIG. 15 illustrate user prioritization of images within a system that facilitates image insertion in messages in accordance with an embodiment.

FIG. 16 illustrates combination of text and image within a system that facilitates image insertion in messages in accordance with an embodiment.

FIG. 17 and FIG. 18 illustrate use of advertising images within a system that facilitates image insertion in messages in accordance with an embodiment.

FIG. 19, FIG. 20 and FIG. 21 illustrates a tag search within a system that facilitates image insertion in messages in accordance with an embodiment.

FIG. 22 illustrates expansion of a display for a system that facilitates image insertion in messages in accordance with an embodiment.

FIG. 23 is a flowchart that summarizes inserting an image into a message in accordance with an embodiment.

### DESCRIPTION OF THE EMBODIMENT

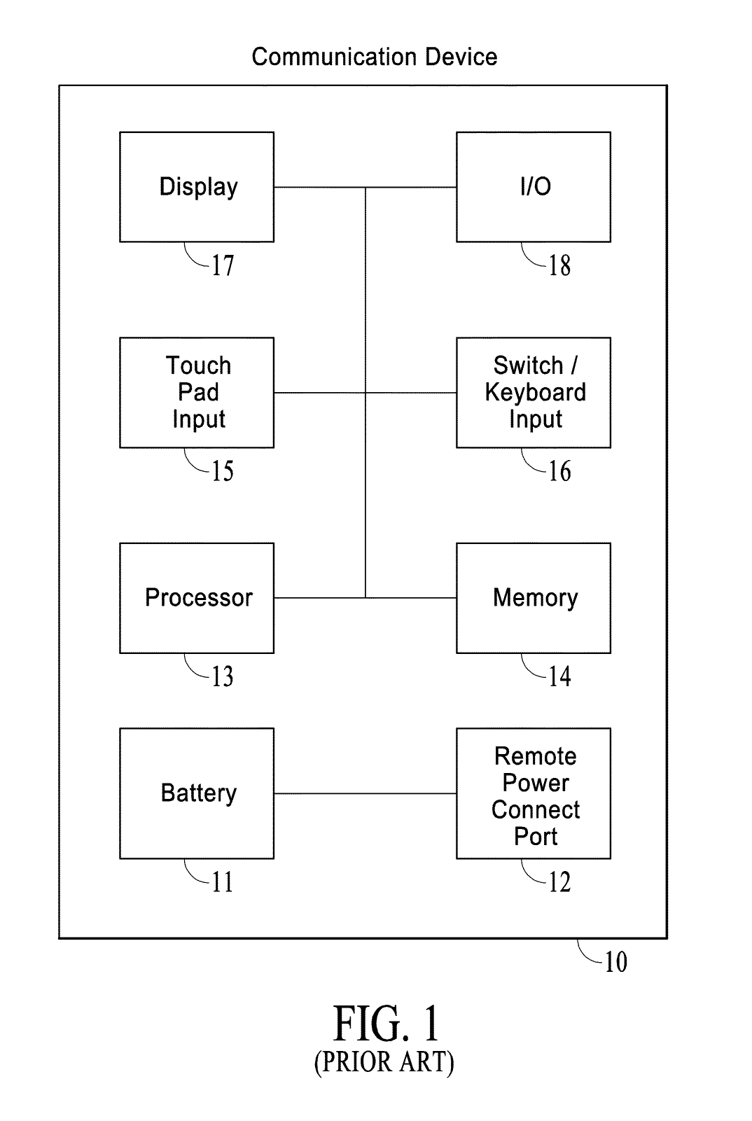

FIG. 1 shows a simplified block diagram of a communication device 10. For example, communication device 10 is a smart phone, a tablet computer, a laptop computer, a desktop computer or some other type of computing device or other device that has a user interface and enables communication with another communication device or a user using another communication device.

Communication device 10 includes, for example, a display 17, a touch pad input 15, a processor, a memory 14, a physical switch/keyboard input 14. In addition, communication device includes a power source such as a battery 11 and/or a remote power connection port 12.

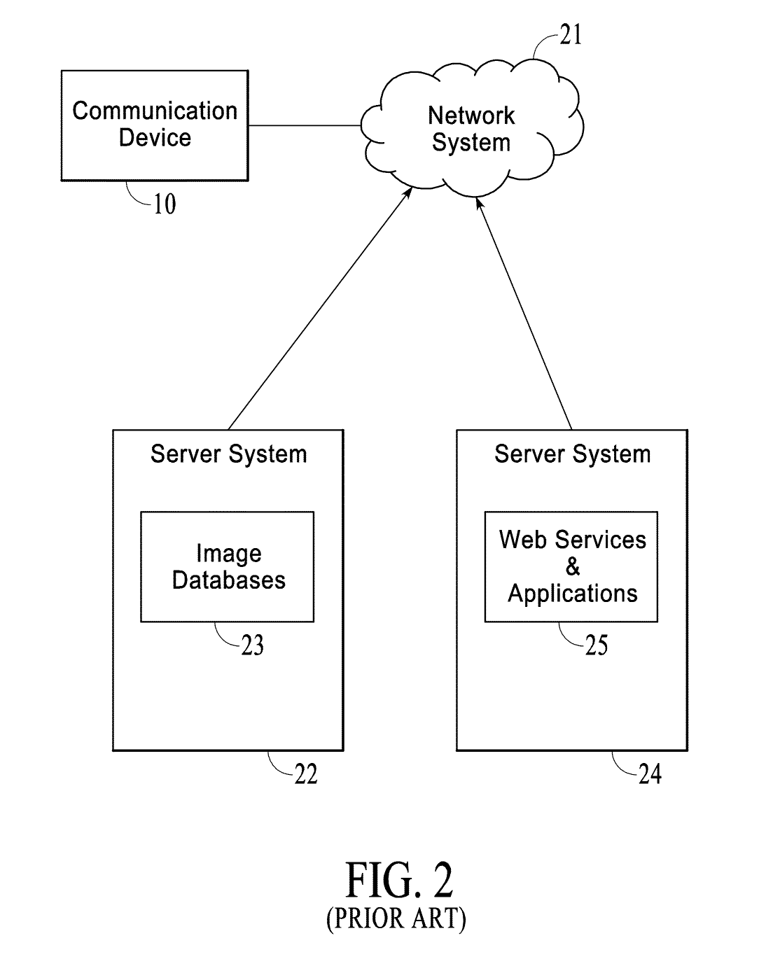

FIG. 2 shows communication device 10 connect through a network system 21 to a server system 22 and a server system 24. For example, network system 21 represents one or a combination of networks such as the Internet, phone network systems, local area networks and other communication entities that allow communication between computing systems. Server system 22 includes one or more image databases 23. Server system 24 includes one or more web services and applications 25. Server system 22 and server system 24 are representative of resources available through communication connection systems such as the Internet. Such servers can include web services such as application servers, database services, image servers, web servers and so on.

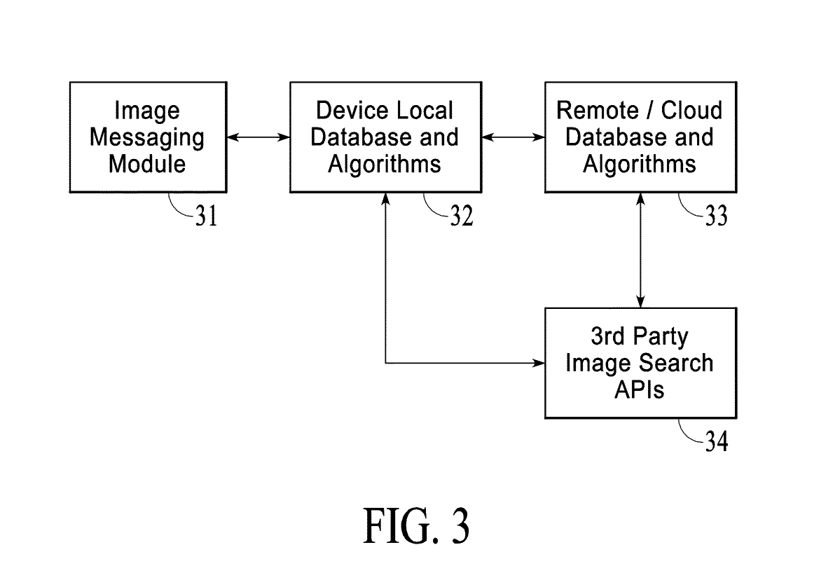

As illustrated by FIG. 3, within communication device 10, an image messaging module 31 communicates with a device local database and algorithms 32. Device local database and algorithms 32 accesses, for example, remote/cloud database algorithms 33, such as those that reside, for example, on a server such as server system 24 and server system 22. Device local database and algorithms 32 also may access, for example, third party image search application programming interfaces 34.

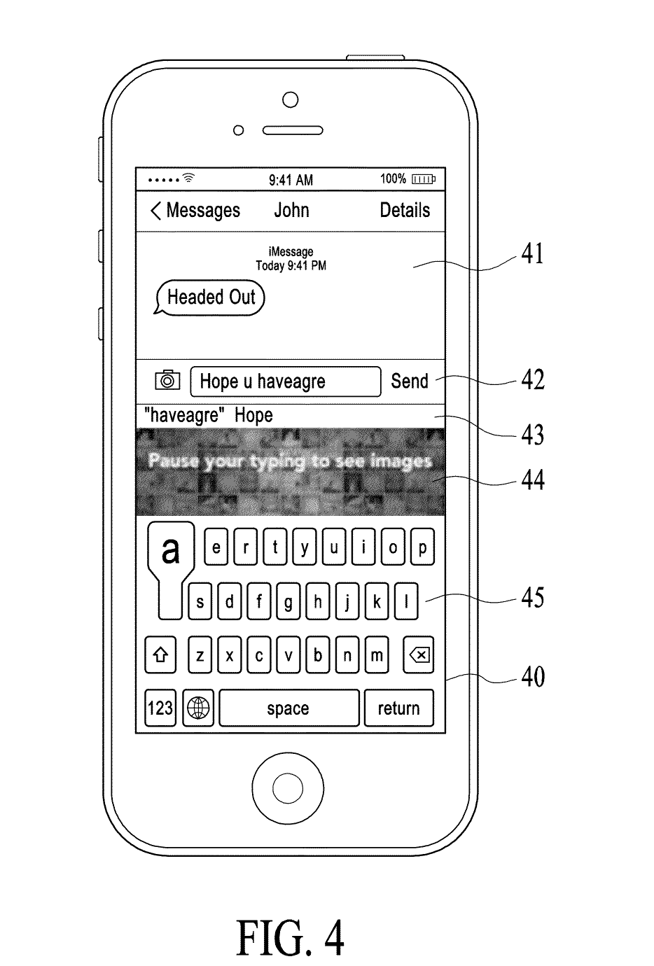

For example, image messaging module 31 implements a user interface that facilitates image insertion in messages. This is illustrated by interface 40, implemented, for example, on a touchscreen display of a smartphone or other computing device. In FIG. 4, interface 40 is shown to include a message history area 41, a current message display buffer 42, a keyword display area 43, an image display area 44 and a keyboard 45.

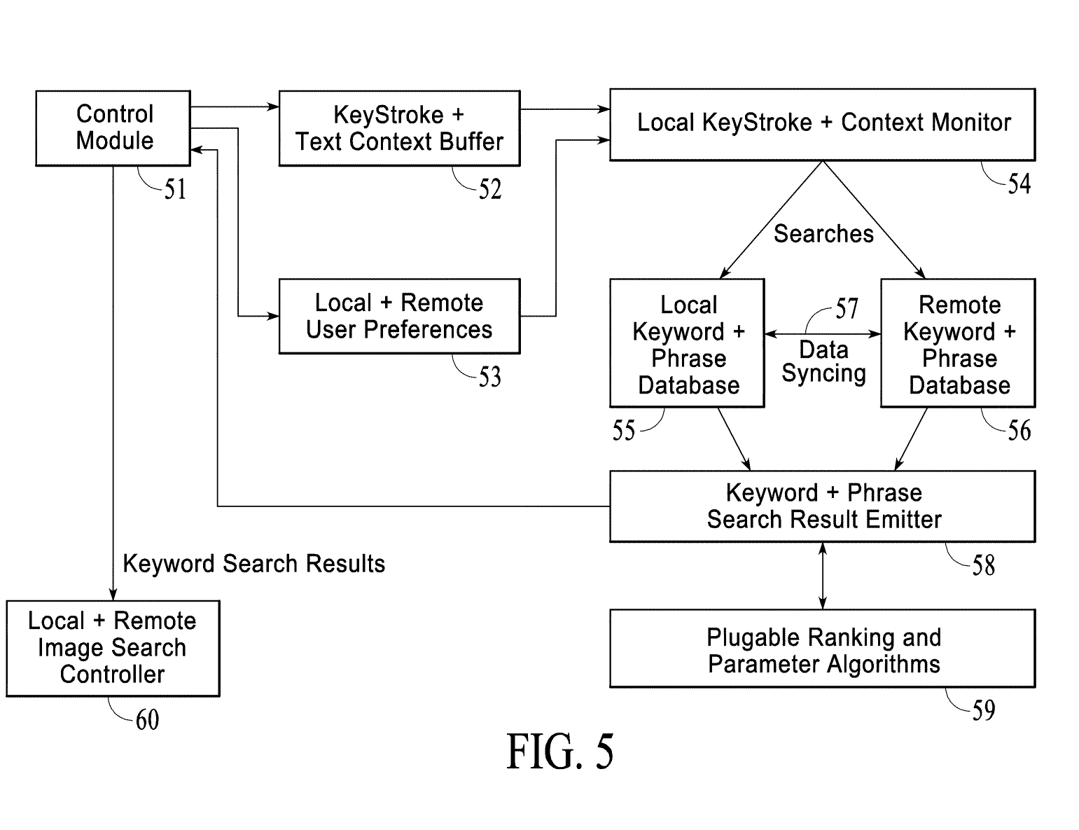

FIG. 5 illustrates an implementation of keyword searching for placement of keywords within keyword display area 43 (shown in FIG. 4). A control module 51 receives text typed within current message display buffer 42 (shown in FIG. 4) into a key stroke plus text context buffer 52. A local key stroke plus context monitor 54 examines key stroke plus text context buffer 52 and accesses local and remote user preferences 53 to implement a search. Local and remote user preferences 53 are user preferences recorded either locally within memory 14 of communication device 10, or remotely, for example in server system 24 (shown in FIG. 2).

For example, a search is performed in a local keyword plus phrase database 55 within memory 14 of communication device 10. Alternatively or in addition, a search is performed in a remote keyword plus phrase database 56 located in a remote storage location, such as in server system 24 (shown in FIG. 2). For example, arrow 57 represents data synchronization being performed between local keyword plus phrase database 55 and remote keyword plus phrase database 56 when both local keyword plus phrase database 55 and remote keyword plus phrase database 56 are searched for potential keywords. For example, searches in local keyword plus phrase database 55 and remote keyword plus phrase database 56 can include, for example, synonyms and common phrases. Searches can also take into account user history of earlier searches and/or user preferences se set out in local plus remote user preferences 53.

A keyword plus phrase search result emitter 58 receives input from local keyword plus phrase database 55 and/or remote keyword plus phrase database 56. To generate results, keyword plus phrase search result emitter 58 uses pluggable ranking and parameter algorithms 59. Pluggable ranking and parameter algorithms 59, for example are algorithms that aid in ranking results from keyword plus phrase search result emitter 58 receives input from local keyword plus phrase database 55 and/or remote keyword plus phrase database 56 in order to select a single result that pluggable ranking and parameter algorithms 59 returns to control module 51. Control module 51 represents the results as a keyword within keyword display area 43 (shown in FIG. 4).

For example control module 51, key stroke plus text context buffer 52, local key stroke plus context monitor 54, keyword plus phrase search result emitter 58 are all implemented with communication device 10 (shown in FIG. 1). Alternatively, parts of this functionality may be implemented remotely.

For example, control module 51 places results from keyword plus phrase search result emitter 58 into keyword display area 43. For a keyword based on information currently being typed into current message display buffer 42, a keyword result may be displayed based on real time typing of text within current message display buffer 42. Thus, results for the keyword will be continuously displayed and changing as text is typed into current message display buffer 42. Alternatively, control module 51 can wait for a pause in typing before updating information in keyword display area 43. For example, the length of the pause can be a user selectable features that is placed by control module 51 into local and remote user preferences 53.

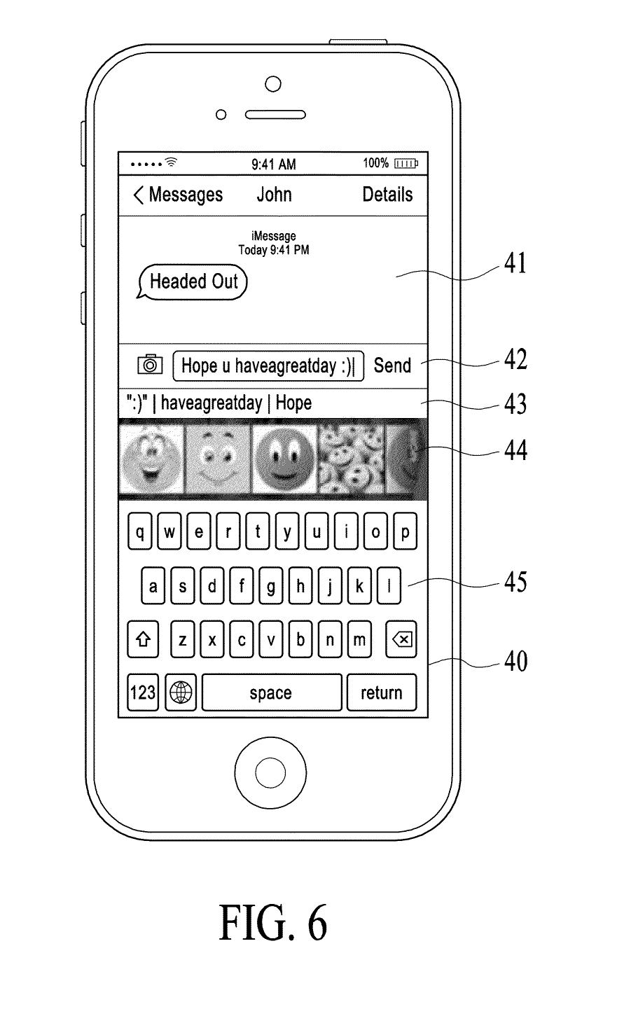

Keywords within keyword display area 43 are parsed, for example, by local key stroke plus context monitor 54. For example, a completed keyword is recognized, for example, by a boundary such as a space, comma or period. In addition to a current keyword, keyword display area 43 contains a history of past keywords. Thus, in FIG. 6, current message display buffer 42 has the typed phrase “Hope u haveagreatday :)” which has been broken down into keywords “:)”, “haveagreatday” and “Hope” in keyword display area 43. For example, in message display buffer 42 typed text is recorded left-to-right while in keyword display area 43, new keywords are added on the left side of keyword display area 43. For example, an “ignore list” stored locally within communication device 10 or remotely lists word that will be ignored. These words are, for example, such words as prepositions, articles and also words deemed to be offensive. Best matches for partial words and parsing of run-on words (several words without spaces in between) can also be performed. Additionally, keyboard display area 43 can be scrolled so that keywords not currently displayed can be accessed by, for example, a user performing a “swipe” function on keyboard display area 43 to display the additional keywords.

In FIG. 6, image display area 44 displays images for a selected keyword in keyword display area 43. For example, the default selected keyword is the leftmost completed or partially completed keyword in keyword display area 43. In FIG. 6, the images in image display area 44 are selected based on the default keyword “:)”. Alternatively, a user can select another keyword in keyword display area 43 by touching the selected keyword or using some other available selection technique.

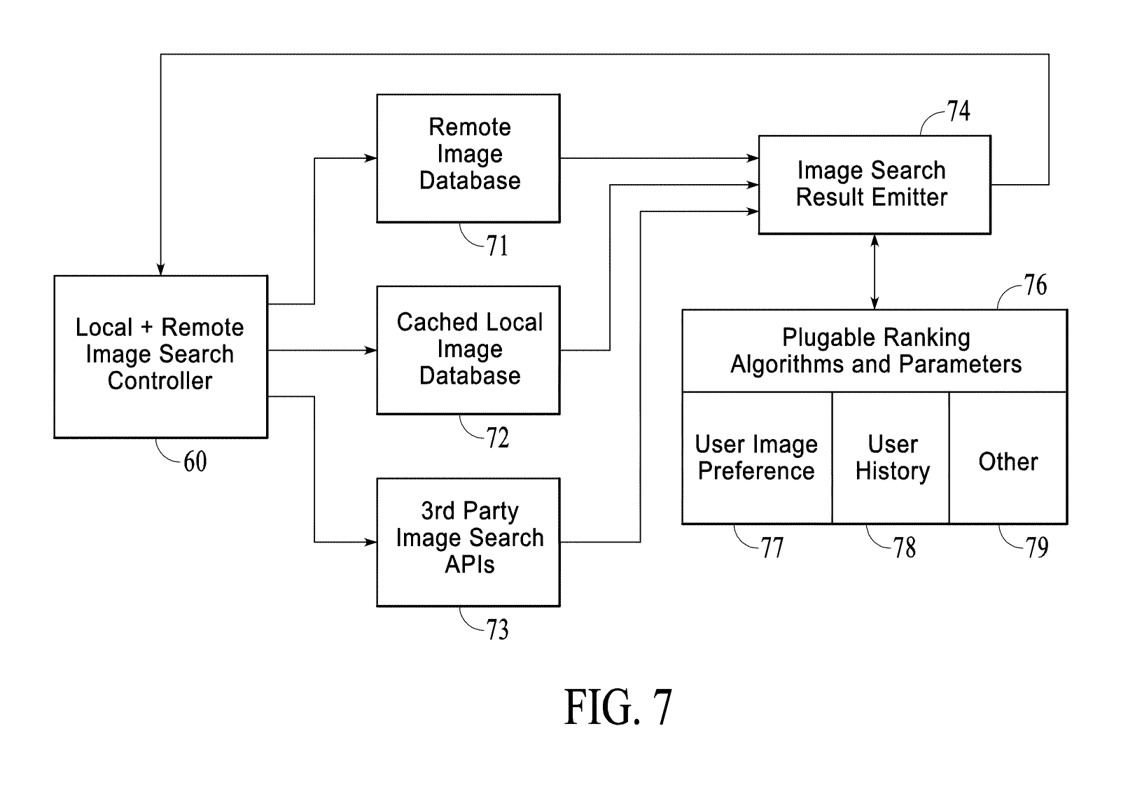

Local plus remote image search controller 60, shown in FIG. 5 and in FIG. 7, is used to select images to be placed in image display area 44. FIG. 7 gives implementation detail of the selection of images to be placed in image display area 44.

As shown in FIG. 7, local plus remote image search controller 60 accesses one or more of a remote image database 71, a cached local image database 72 and third party image search application program interfaces 73 to obtain potential images. An image search result emitter 74 evaluates images received from one or more of a remote image database 71, a cached local image database 72 and third party image search application program interfaces 73 and selects images to return to local plus remote image search controller 60. Image search result emitter 74 uses, for example, pluggable ranking algorithms and parameters 76 to select the images to return to local plus remote image search controller 60.

Pluggable ranking algorithms and parameters 76 utilizes, for example, user image preferences 77, user history 78 and other information 79 to select the images. For example, local plus remote image search controller 60, image search result emitter 74 and pluggable ranking algorithms and parameters 76 are implemented locally within communication device 10. Alternatively, some or all of the functionality of local plus remote image search controller 60, image search result emitter 74 and pluggable ranking algorithms and parameters 76 are located remotely in one or more server systems such as server system 24 and server system 22.

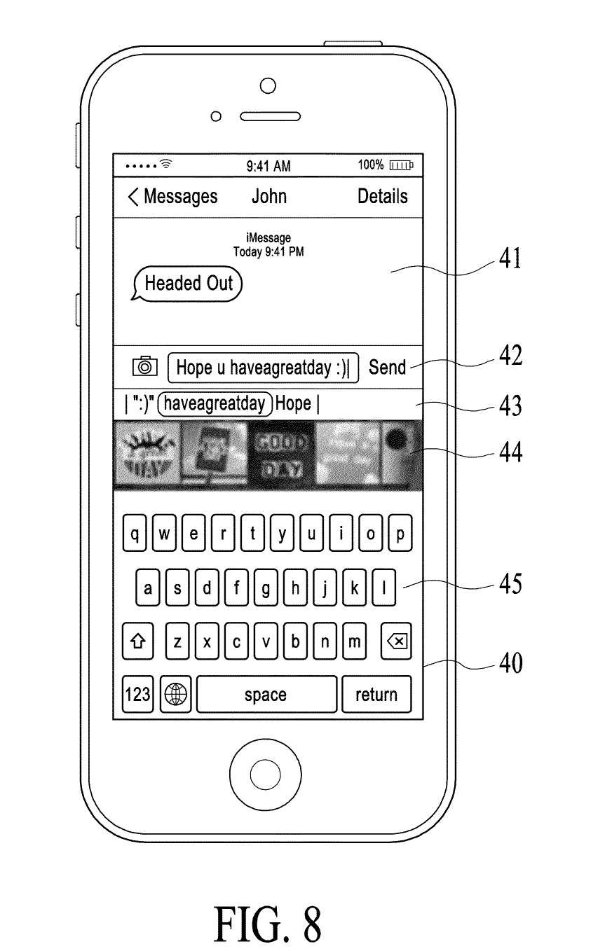

FIG. 8 shows that a user has selected the keyword “haveagreatday”. Thus in FIG. 8, the images in image display area 44 are selected based on the default keyword “haveagreatday”.

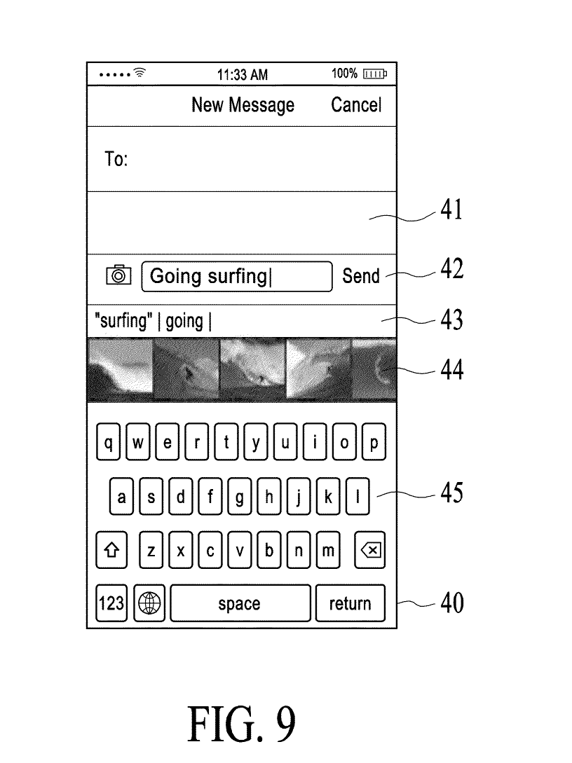

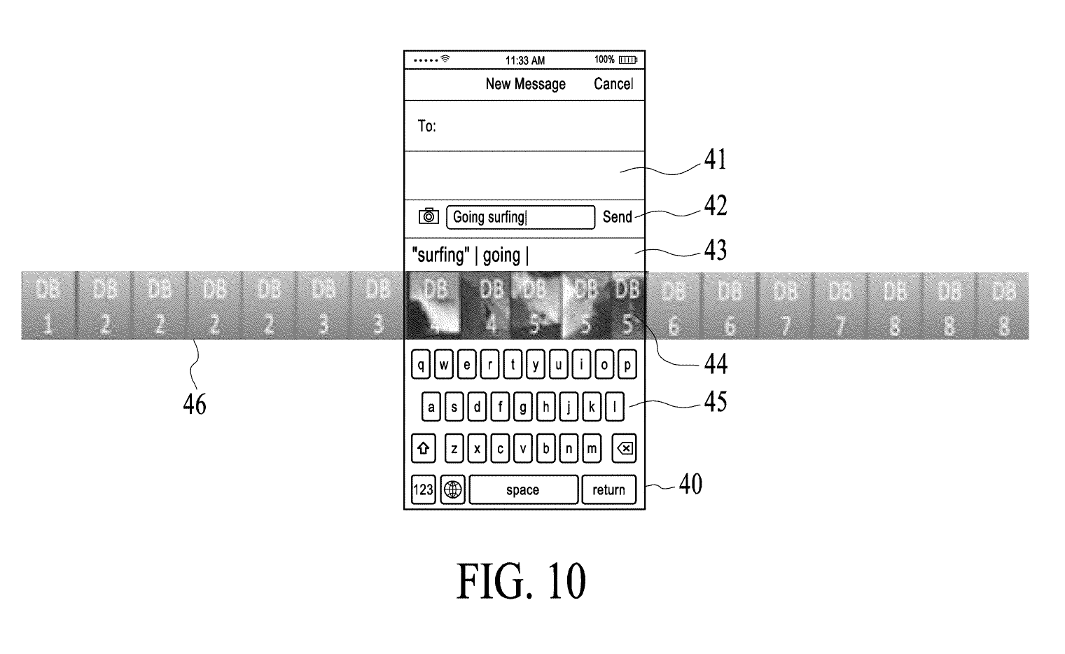

FIG. 9 shows current message display buffer 42 has the typed phrase “Going surfing” which has been broken down into keywords “surfing” and “going” in keyword display area 43. In FIG. 9, the images in image display area 44 are selected based on the default keyword “surfing”. While five images are currently shown in image display area 44, more and different images may be displayed by swiping image display area 44 to the right or to the left. As represented in FIG. 10, image display area 44 displays images from a buffer 46 of images selected and prioritized by pluggable ranking algorithms and parameters 76.

For example, as buffer 46 is represented in FIG. 10, images in buffer 46 are labeled “DB ‘x’” where ‘x’ is a number that represents a database that is the source of the image. For example, database “DB” 1 represents, a database of user tagged images. For example, database “DB” 2 represents a database of recently used images or some other historic collection of images. For example, database “DB” 3 represents, for example, top quality images from a proprietary database. For example, database “DB” 4 represents, for example, medium quality images from a proprietary database. For example, database “DB” 5 represents, advertising images from an ad firm. For example, database “DB” 6 represents, advertising images from a search engine, such as Google search. For example, database “DB” 7 represents, images from a search engine, such as Bing search. For example, database “DB” 8 represents, images from a visual discovery tool, such as the Pinterest visual discover tool.

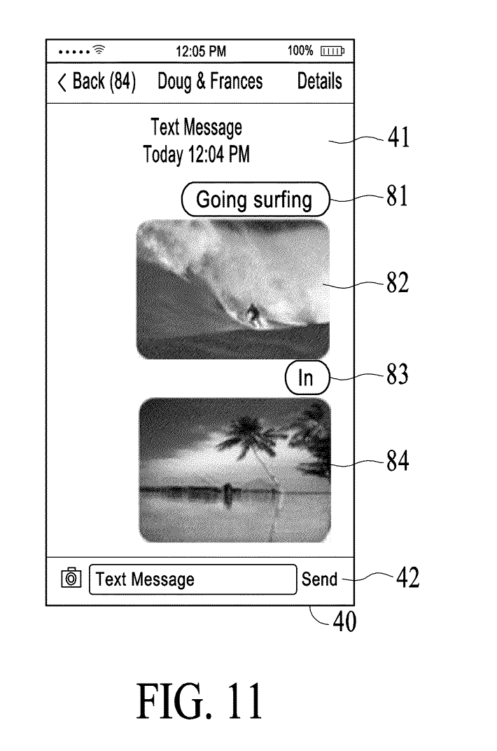

Images in image display area 44 are actionable. For example, selecting an image (e.g., by touching on a touch screen) adds the word to an expanded current message display buffer 42. When the message is sent, the message includes the image. Or example, FIG. 11 shows a received message in message history area 41. The original sent text was “Going surfing In Hawaii”. The user elected to include with the text “Going surfing” 81 an image 82 showing surfing. The text “In” is included without an image. The image 84 has been selected by the user to replace the text “Hawaii”.

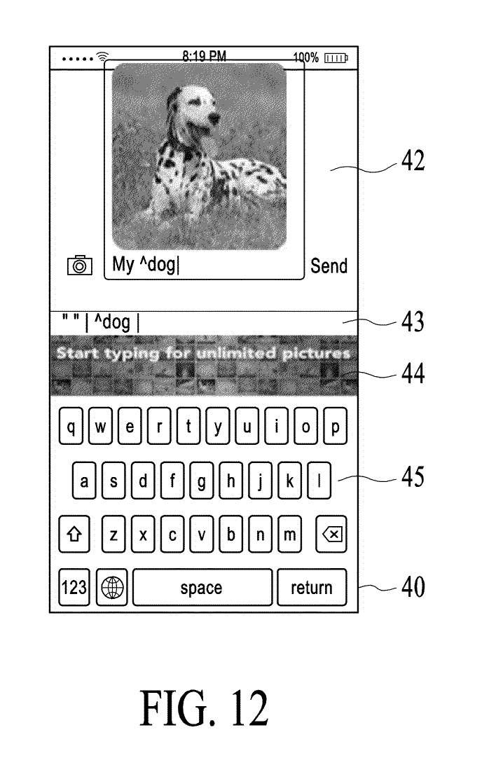

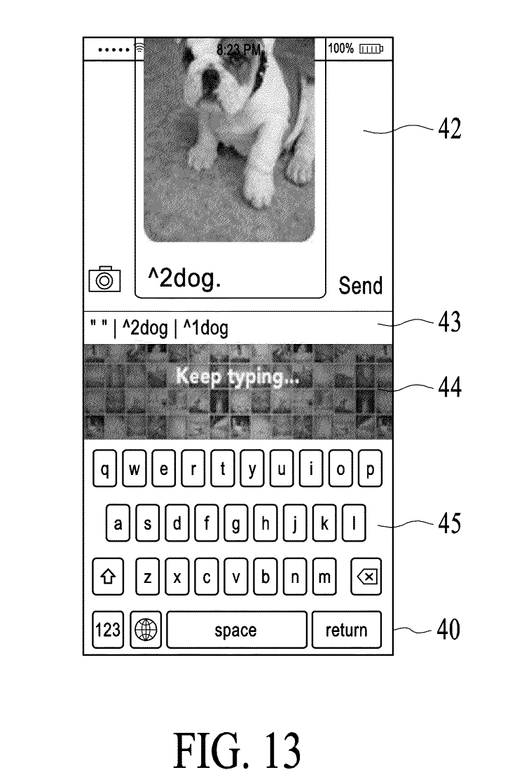

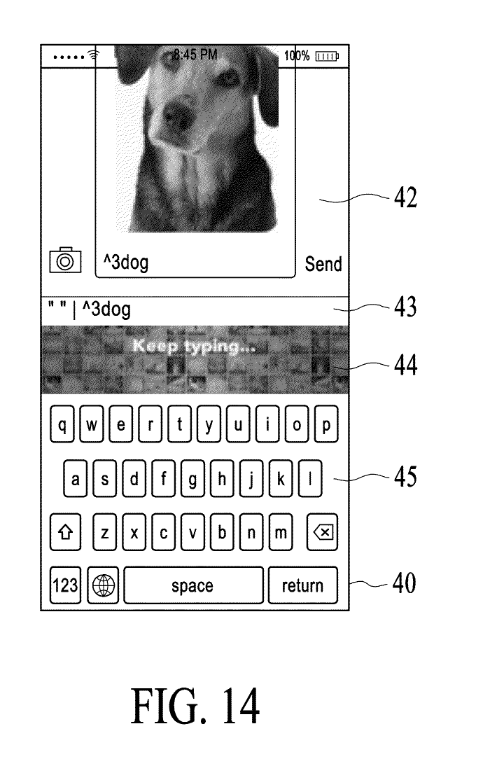

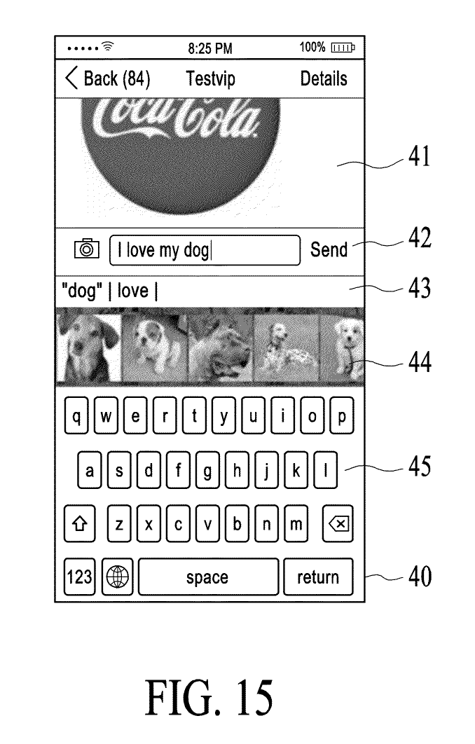

FIG. 12 shows an image of a dog within an expanded current message display buffer 42. A special character, in this case the character “̂” has been used to signify a tagged image stored previously by the user. Although in FIG. 12, the special character “̂” is used, another special character could be used to indicate a tagged image. The image of a dog shown in FIG. 12 is associated, for example, with the term “̂dog” in a database of user tagged images such as database “DB” 1.

Other images of dogs may also be stored in the same database of user tagged images by adding a number after the special character “̂”. For example, FIG. 13 shows an image of a dog associated with the term “̂2dog” accessed, for example, from within a database of user tagged images such as database “DB” 1. FIG. 14 shows an image of a dog associated with the term “̂3dog” accessed, for example, from within a database of user tagged images such as database “DB” 1.

FIG. 15 illustrates how user tagged images within database “DB” 1 take precedence when the term dog is used as a keyword. For example, the imaged tagged with the highest number next to the special character can have the highest precedence. This is illustrated, for example, by the image of a dog with the tag “̂3” being in the highest priority position on the left of image display area 44. The next highest priority slot is taken up by the image of a dog with the tag “̂2”. The next highest priority slot is taken up by an image of a dog with the tag “̂1”. The next highest priority slot is taken up by the image of a dog with the tag “̂”. Images to the right of the tagged images are images of dogs from other databases, as explained further in the discussion of FIG. 10 above.

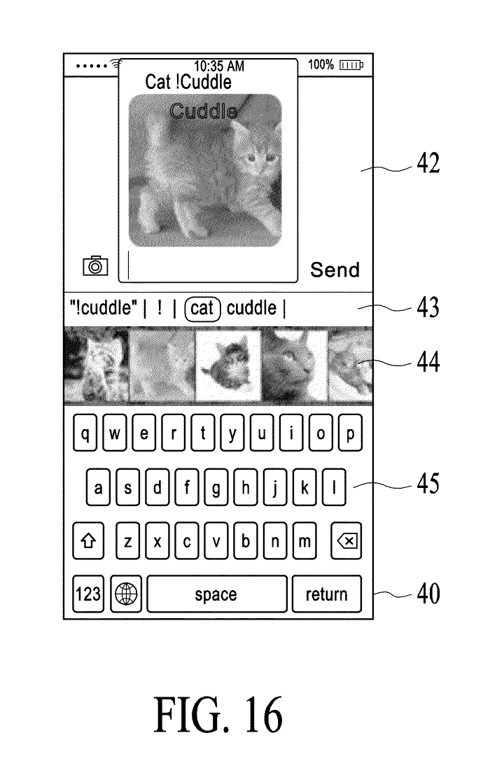

FIG. 16 illustrates use of a special character to embedded a text within an image. As shown in FIG. 16, from keyword display area 43 the user has selected an image of a cat to be added to current message display buffer 42. Then the image typed the phrase “!Cuddle” into current message display buffer 42. Selecting the term “!Cuddle” from keyword display area 43 inserts the text “Cuddle” into the image of the cat shown in current message display buffer 42. When sent, the term “!Cuddle” outside the cat will not be sent as part of the message, instead the image of the cat with the embedded word “Cuddle” will be sent. Alternatively, selecting and holding a word in keyword display area 43 also indicates the text of the keyword will be embedded within an image displayed in current message display buffer 42.

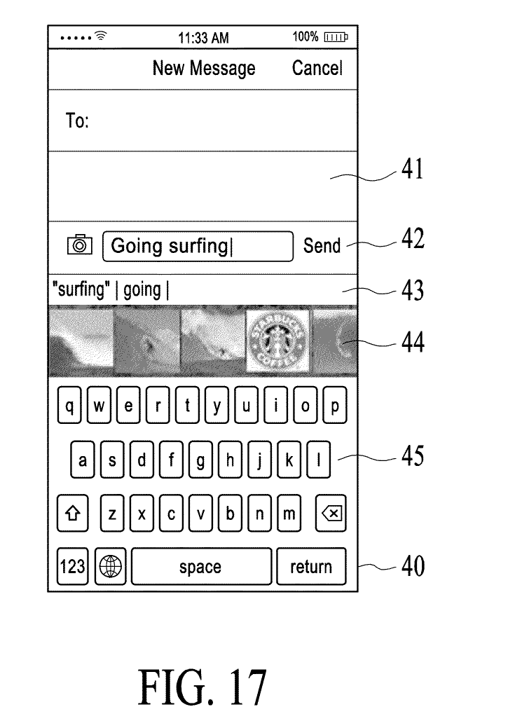

FIG. 17 shows an advertising image being included in image display area 44 along with other images associated with the selected by default keyword “surfing”. For example, the advertising images come from an advertising database such as database “DB” 5, as explained further in the discussion of FIG. 10 above. The insertion of advertisements provides a way of monetizing use of an app that inserts images in a message.

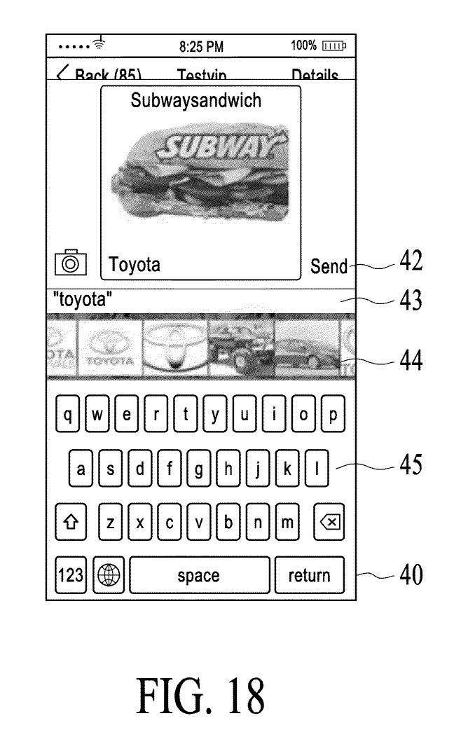

As illustrated by FIG. 18 advertising images can be stored in an advertising database such as database “DB” 5 and accessed using keywords associated with the advertisement, or accessed by some other criteria, dependent on preselected preferences of the user or the provider of an application.

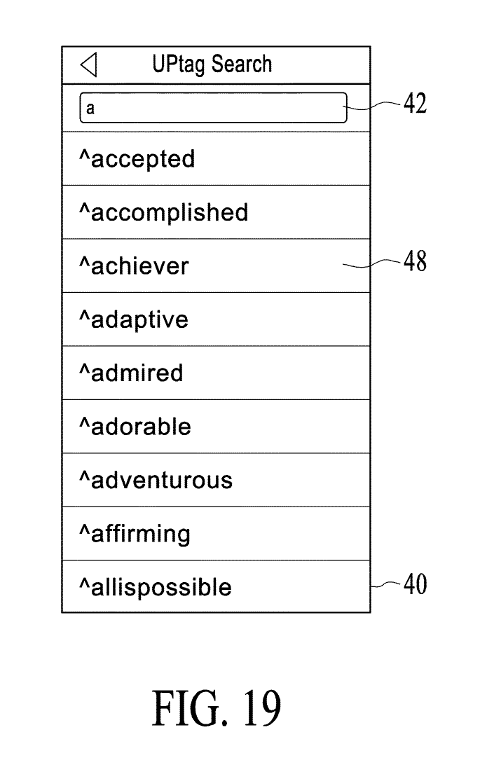

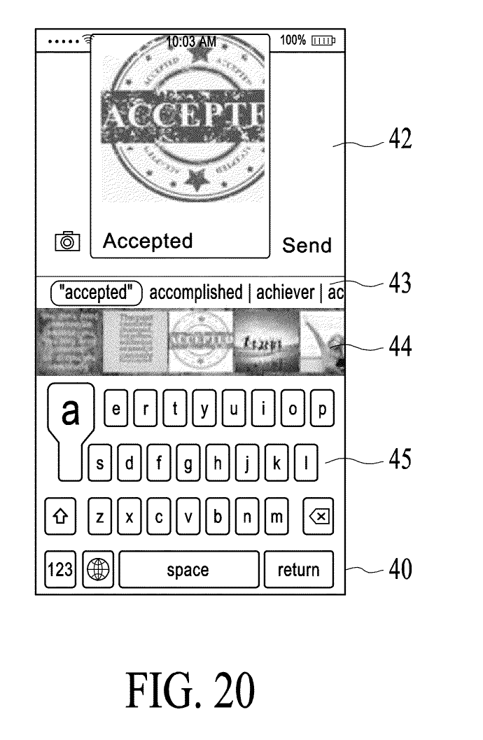

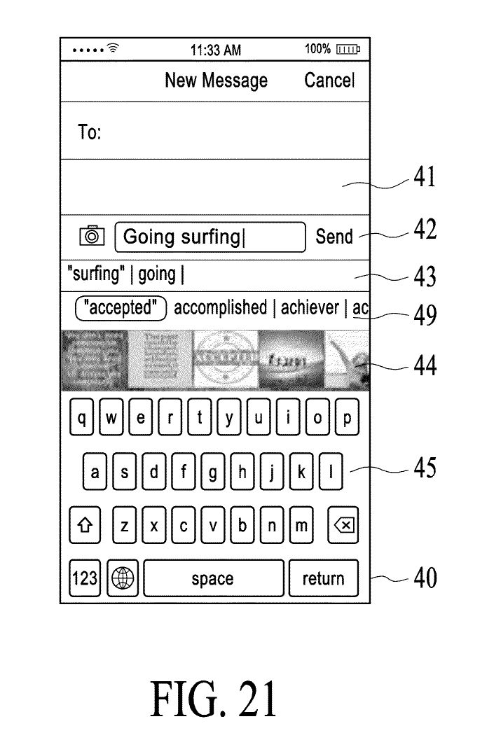

FIG. 19 illustrates a special search feature. By selecting and holding a letter on keyboard 45, control module 51 (shown in FIG. 5) will arrange for searching of a dedicated database containing themed keywords. For example, the dedicated database includes words and/or phrases used for encouragement and approbation. This is illustrated in display area 48 shown in FIG. 19, where positive and encouraging keywords and phrases beginning with the letter “a” are listed as a result of the user selecting and holding the letter “a”. Alternatively, or in addition, positive and encouraging keywords and phrases need not be associated with a letter but with any character on keyboard 45. For example, holding the character “+” can result in an assortment of positive and encouraging keywords and phrases appearing within a display area such as display area 48. Any character can be associated with a word list that is brought up by selecting and holding the character on keyboard 45.

For example, as illustrated by FIG. 20, when one of the positive and encouraging keywords is selected (e.g., “Accepted”), the keyword appears in current message display buffer 42 and is added to keyword display area 43. Alternatively, positive and encouraging keywords and phrases beginning with the letter “a” are automatically inserted into keyword display area 43 as a result of the user selecting and holding the letter “a” (or some other character, as described above).

Images associated with a selected keyword are included in image display area 44. The images with the highest priority may be selected from a local or remote database associated with the themed database of keywords.

To increase versatility, additional keyword display areas and/or image display areas may be added. For example, FIG. 21 shows the addition of an additional keyword display area 49 added to interface 40. For example, as shown in FIG. 21, keyword display area 43 is used to provide keywords based on text within current message display buffer 42. Keyword display area 49 is used to display positive and encouraging keywords and phrases beginning with the letter “a”, as called for by a user selecting and holding the “a” key on keyboard 45. Selecting a keyword from either keyword display area 43 or keyword display area 49 results in images for the keyword appearing in image display area 44.

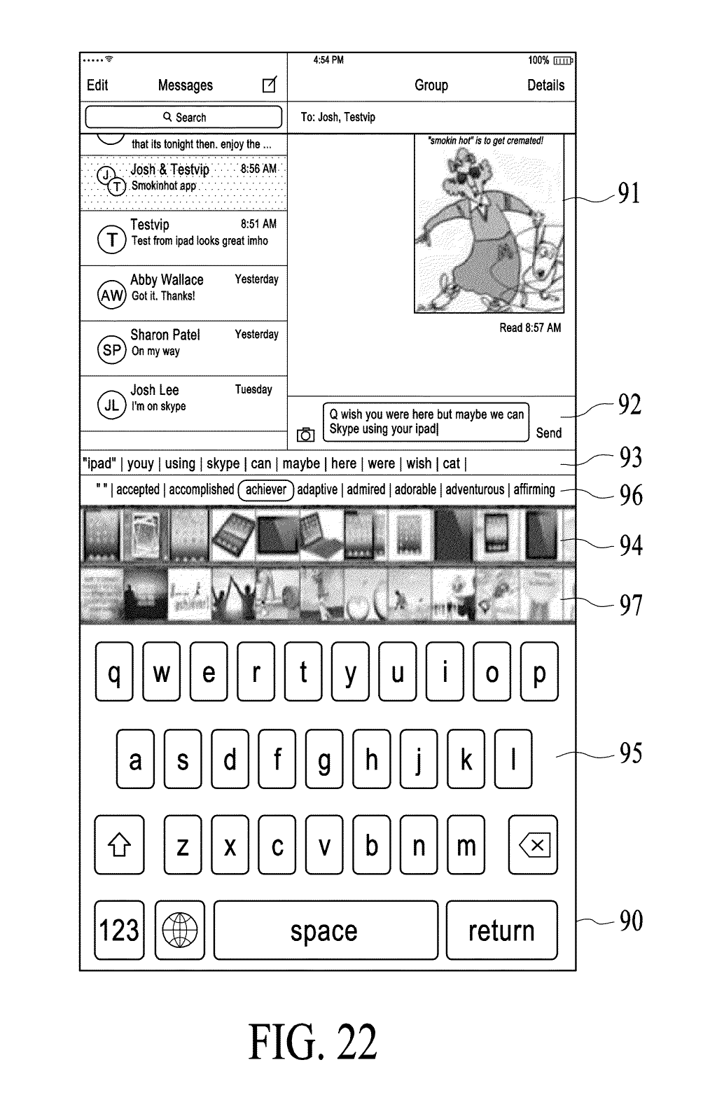

FIG. 22 gives an example of an interface 90 that has two word scroll areas and two image display areas. For example, image messaging module 31 (shown in FIG. 3) implements interface 90, for example, on a tablet device. In FIG. 22, interface 90 is shown to include a message history area 91, a current message display buffer 92, a keyword display area 93, a keyword display area 96, an image display area 94, an image display area 97, a keyboard 95 and a message history area 98.

For example, as shown in FIG. 22, keyword display area 93 is used to provide keywords based on text within current message display buffer 92. Keyword display area 96 is used to display positive and encouraging keywords and phrases beginning with the letter “a”, as called for by a user selecting and holding the “a” key on keyboard 95. Selecting a keyword from keyword display area 93 results in images for the keyword appearing in image display area 94. Selecting a keyword from keyword display area 96 results in images for the keyword appearing in image display area 97.

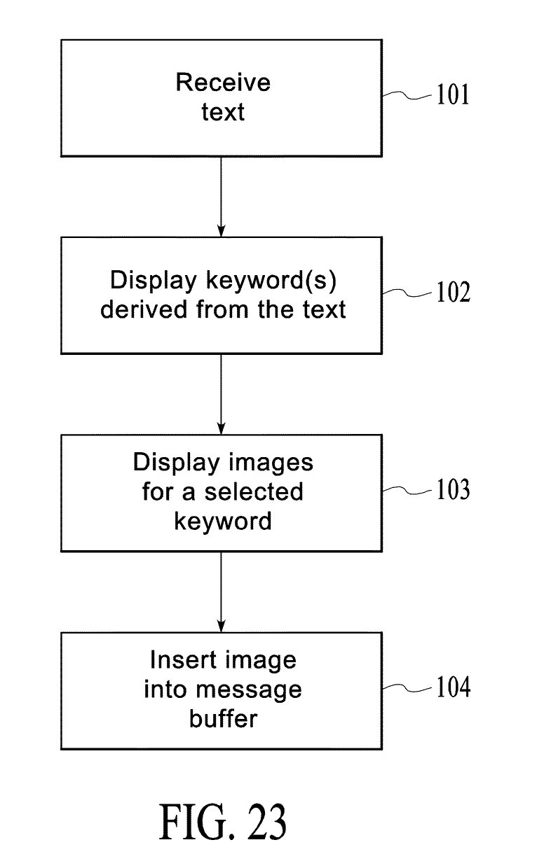

FIG. 23 is a flowchart that summarizes inserting an image into a message. In a block 101, text is received into a current message display buffer of a communication device. For example, in FIG. 4, a user types text into current message display buffer 42.

In a block 102, at least one keyword derived from the text is displayed in a keyword display area. This is illustrated, for example, in FIG. 6 where the keywords “:)”, “haveagreatday” and “Hope” are displayed in keyword display area 43.

For example, a keyword is derived from text last entered into current message display buffer when a user inserts a space, a comma, or a period. For example, a keyword derived from text last entered into current message display buffer is selected when a user pauses from entering text for a predetermined length of time.

In a block 103, a plurality of images for a selected keyword are displayed when the selected keyword is selected from among the at least one keyword displayed in the keyword display area. This is illustrated, for example, in FIG. 6 where images are displayed in image display area 44 for the keywords “:)”.

For example, a last entered keyword is selected as the selected keyword when a user pauses from entering text for a predetermined length of time.

For example, images are displayed from a plurality of databases. For example, at least one database from the plurality of databases is stored within the communication device and at least one database from the plurality of databases is stored at a location remote from the communication device. For example, the images can be scrolled to see additional images, as illustrated by FIG. 10.

In a block 104, an image is inserted into the current message display buffer from the plurality of images when the image is selected from among the plurality of images. This is illustrated, for example, by FIG. 16 where an image of a cat selected in image display area 44 has been inserted into current message display buffer 42.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A computer implemented method to insert an image in a message comprising:
receiving text in a current message display buffer of a communication device;
displaying at least one keyword derived from the text in a keyword display area;
displaying a plurality of images for a selected keyword when the selected keyword is selected from among the at least one keyword displayed in the keyword display area; and,
inserting an image into the current message display buffer from the plurality of images when the image is selected from among the plurality of images.

2. A computer implemented method as in claim 1 wherein displaying the at least one keyword includes the following:
displaying a new keyword when a user pauses from entering text for a predetermined length of time.

3. A computer implemented method as in claim 1 wherein displaying a plurality of images for a selected keyword from the text includes the following:
selecting a last entered keyword as the selected keyword when a user pauses from entering text for a predetermined length of time.

4. A computer implemented method as in claim 1 wherein displaying at least one keyword derived from the text includes the following:
deriving a keyword from text last entered into current message display buffer when a user inserts a space, a comma, or a period.

5. A computer implemented method as in claim 1 wherein displaying at least one keyword derived from the text includes the following:
deriving a keyword from text last entered into current message display buffer when a user pauses from entering text for a predetermined length of time.

6. A computer implemented method as in claim 1 wherein displaying a plurality of images for a selected keyword from the text includes the following:
selecting, by a user, a keyword from the at least one keyword displayed in the keyword display area as the selected keyword.

7. A computer implemented method as in claim 1 wherein displaying a plurality of images for a selected keyword from the text includes the following:
displaying images from a plurality of databases, at least one database from the plurality of databases being stored within the communication device and at least one database from the plurality of databases being stored at a location remote from the communication device.

8. A computer implemented method as in claim 1 wherein displaying a plurality of images for a selected keyword from the text includes the following:
displaying additional images in response to a user scrolling the plurality of images.

9. A computer implemented method as in claim 1 wherein displaying a plurality of images for a selected keyword from the text includes the following:
displaying an image from a themed database when the selected keyword starts with a preselected special character.

10. A computer implemented method as in claim 1 additionally comprising:
embedding text over the image displayed in the current message display buffer when the text preceded by a preselected special character is entered into the current message display buffer.

11. A computer implemented method as in claim 1 additionally comprising:
embedding text over the image displayed in the current message display buffer when the text preceded by a preselected special character is selected from the keyword display area.

12. A computer implemented method as in claim 1 wherein displaying a plurality of images for a selected keyword from the text includes the following:
displaying images from a plurality of databases, at least one database from the plurality of databases storing advertising images that advertise a product, service or business.

13. A computer implemented method as in claim 1 additionally comprising:
displaying a list of words associated with a character on a keyboard when the character is selected and held for a predetermined length of time; and,
inserting a word from the list of words into the keyword display as a keyword.

14. A computer implemented method as in claim 1 additionally comprising:
displaying a list of words associated with a character on a keyboard when the character is selected and held for a predetermined length of time; and,
inserting a word from the list of words into the keyword display as a keyword;
displaying images from a special themed database when the word for the word is the selected keyword.

15. A computer implemented method as in claim 1 additionally comprising:
displaying a list of words starting with a letter selected on a keyboard when the letter is selected and held for a predetermined length of time, the list of words appearing in a second keyword display; and,
displaying a plurality of images for a selected keyword from the second keyword display when the selected keyword from the second keyword display is selected.

16. A computer implemented method as in claim 1 additionally comprising:
embedding text of a keyword over the image displayed in the current message display buffer when the keyword is selected and held for a predetermined length of time.

17. An communication device, comprising:
a device display;
a processor;
memory; and,
programming code stored in the memory and executing on the processor, the programming code causing contents of a current message display buffer to be displayed on the device display;
wherein, the programming code causes at least one keyword derived from text in the current message display buffer to be displayed in a keyword display area of the device display;
wherein the programming code causes a plurality of images for a selected keyword to be displayed when the selected keyword is selected from among the at least one keyword displayed in the keyword display area; and,
wherein the programming code causes an image from the plurality of images to be inserted into the current message display buffer when the image is selected from among the plurality of images.

18. A communication device as in claim 17 wherein the plurality of images are accessed from a plurality of databases, at least one database from the plurality of databases being stored at a location remote from the communication device.

19. A communication device as in claim 17 wherein the programming code causes the device display to display an image from a themed database when the selected keyword starts with a preselected special character.

20. A communication device as in claim 17 wherein the programming code embeds text over the image displayed in the current message display buffer when the text preceded by a preselected special character is entered into the current message display buffer.

21. A communication device as in claim 17 wherein the programming code embeds text over the image displayed in the current message display buffer when the text preceded by a preselected special character is selected from the keyword display area.

22. A communication device as in claim 17 wherein the programming code selects a last entered keyword as the selected keyword by default when a user pauses from entering text for a predetermined length of time.

23. Non-transient storage media that stores programming code which when run on a computing device that includes a device display, a processor and memory causes contents of a current message display buffer to be displayed on the device display;
wherein, the programming code causes at least one keyword derived from text in the current message display buffer to be displayed in a keyword display area of the device display;
wherein the programming code causes a plurality of images for a selected keyword to be displayed when the selected keyword is selected from among the at least one keyword displayed in the keyword display area; and,
wherein the programming code causes an image from the plurality of images to be inserted into the current message display buffer when the image is selected from among the plurality of images.

24. Non-transient storage media as in claim 23 wherein the plurality of images are accessed from a plurality of databases, at least one database from the plurality of databases being stored at a location remote from the communication device.

25. Non-transient storage media as in claim 23 wherein the programming code embeds text over the image displayed in the current message display buffer when the text preceded by a preselected special character is entered into the current message display buffer.

26. Non-transient storage media as in claim 23 wherein the programming code embeds text over the image displayed in the current message display buffer when the text preceded by a preselected special character is selected from the keyword display area.

27. Non-transient storage media as in claim 23 wherein the programming code causes the device display to display an image from a themed database when the selected keyword starts with a preselected special character.

28. Non-transient storage media as in claim 23 wherein the programming code selects a last entered keyword as the selected keyword by default when a user pauses from entering text for a predetermined length of time.
